(19) United States
(12) Patent Application Publication
(10) Pub. No.: US 2021/0366445 A1
(43) Pub. Date: Nov. 25, 2021

(54) SYSTEM AND METHOD FOR FRACTIONALLY REPRESENTING TIME SIGNATURES FOR USE IN MUSIC COMPUTER PROGRAMS AND METRONOMES

(71) Applicant: Matthew LEDGAR, Bonville (AU)

(72) Inventor: Matthew LEDGAR, Bonville (AU)

(21) Appl. No.: 17/325,311

(22) Filed: May 20, 2021

Related U.S. Application Data
(60) Provisional application No. 63/027,503, filed on May 20, 2020.

(51) Int. Cl. G10G 1/04; G06F 3/0482; G06F 3/0488

(52) U.S. Cl. CPC G10G 1/04; G06F 3/04883; G06F 3/0482

(57) ABSTRACT

A system for fractionally representing time signature for use with digital device includes a user interface that enables a user to enter a first number to represent the number of beats per bar; and to enter a second number to represent the number of divisions per beat. The system uses a processing device to run a set of transcription rules to the first and second numbers in response to user selected inputs. A graphical output is used to display a visual representation of the desired fractional output is displayed. The system also includes a method for fractionally representing time signatures with the steps of entering, via an electronic processing device, a first and a second number where the first number represents the number of beats per bar and the second number represents the number of divisions per beat and displays the result on an electronic display.

### CROSS REFERENCE TO RELATED APPLICATIONS

This application claims priority and herein incorporates by reference U.S. provisional patent application 63/027,503, filed May 20, 2020.

### BACKGROUND OF THE INVENTION

Time signatures are used in music to indicate the rhythmic structure of the piece of music which is very helpful to a person playing the music especially if they have not heard the piece performed previously.

In general, modern Western musical notation tends to use a symmetric beat patterns. In present musical time signatures, the time signature appears at the beginning of the piece as either a known symbol such as a “c” for common time or as a fraction such as j, as is known in the art. Although less common in Western music, it is known to use more complex timing notation such as complex, mixed additive, fractional and irrational meters.

In the prior art, fractionally represented time signatures are shown with the numerator representing the notes per bar and the denominator represents the notes length with the two numbers combining to determine bar length. The established system of music notation uses only the numbers 1, 2, 4, 8, 16, 32 and 64 in the denominator. In the case where complex time signatures are desired, qualifying notes are be written above the start of the bar to indicate the desired complex time. This greatly complicates the process of using a digital device such as computer to program a complex time signature overlay.

There is a need for a new system for fractionally representing time signatures for use in music computer programs and metronomes which greatly simplifies the process while keeping continuity with current music notation.

### SUMMARY OF THE INVENTION

A system for fractionally representing time signature for use with digital device includes a user interface that enables a user to enter a first number to represent the number of beats per bar; and to enter a second number to represent the number of divisions per beat. The system uses a processing device to run a set of transcription rules to the first and second numbers in response to user selected inputs. A graphical output is used to display a visual representation of the desired fractional output is displayed. The system also includes a method for fractionally representing time signatures with the steps of entering, via an electronic processing device, a first and a second number where the first number represents the number of beats per bar and the second number represents the number of divisions per beat and displays the result on an electronic display.

Other features and advantages of the instant invention will become apparent from the following description of the invention which refers to the accompanying drawings.

### BRIEF DESCRIPTION OF THE DRAWINGS

FIG. 1 is an illustration of an introduction screen for a system for fractionally representing time signatures for use in music computer programs and metronomes;

FIG. 2 is an illustration of a selection screen according to an embodiment of the invention;

FIG. 3 is an illustration of a new project screen input screen;

FIG. 4 is an illustration of a main screen showing a track visualization area and a sound bank area;

FIG. 5 is an illustration showing a beats indicator and selection input;

FIG. 6 is an illustration showing a selected input;

FIG. 7 is an illustration of a sound bank selection screen;

FIG. 8 is a close-up view of a ring shortcuts input screen;

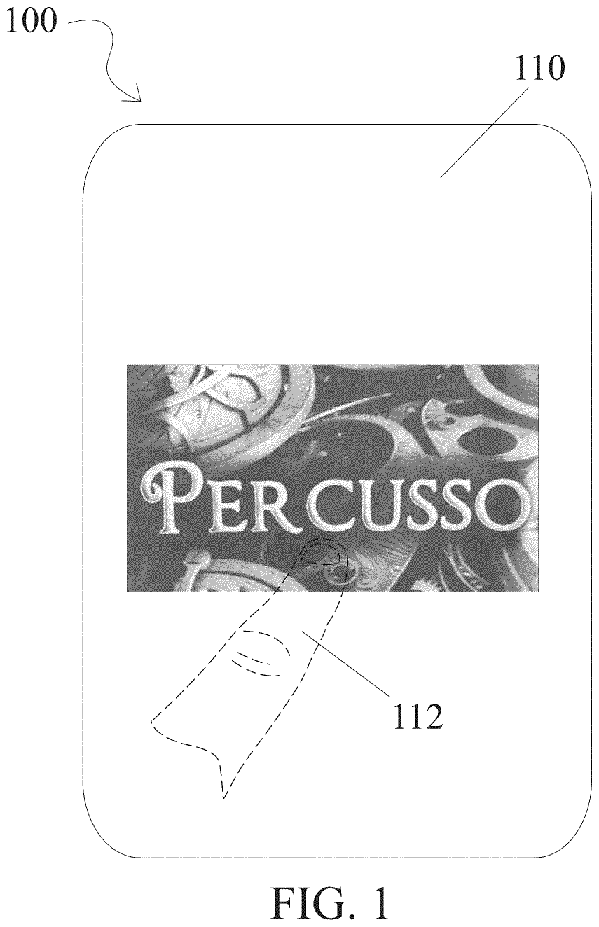

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

An improved system of time signature for use in musical computer programs, metronomes and electronic logic uses a number to represent the number of beats per bar and a second number represents the number of divisions per beat to describe the bar length and transcription rules of a musical score or musical sequence. A further embodiment of the second number allows that when the second number is bracketed it will represent the number of divisions per bar.

In one embodiment, the instant invention uses the following transcription rules:

The second number indicates the note length that will be used to describe each division per beat, the first number represents the number of groups of divisions;

When the second number is not bracketed (divisions per beat), these rules apply
As a prime number doubles so its transcribed length is halved.
Prime numbers below 10, each division has a transcribed length of an 8th note.
Prime number between 10 and 20 each division is transcribed as being a 16th note in length.
Prime numbers over 20 each division is transcribed as a 32nd note.

When the second number is bracketed (division per bar), these rules apply
All divisions are worth an 8th note except 1 which is worth a whole note.
   In another embodiment, the present invention uses the numerator to represent beats per bar, determining the bar length. The denominator represents the subdivisions per beat or bar and determines the notated length of the notes, when the said denominator is not bracketed it is multiplied by the said numerator to find the number of notes per bar, when the denominator is bracketed the denominator alone indicates the number of notes per bar. Prior art time signatures have no way to accurately describe odd groupings like triplets and quintuplets, for example three quintuplets per bar would be described as 15/16 or fifteen, sixteenth notes, which could be interpreted as five triplets or three quintuplets. The present invention would describe three quintuplets as ⅗ and five triplets as 5/3. The inclusion of all positive numbers in the denominator allows the present invention to accurately describe the basic rhythm of the notation that follows. The present invention also solves the problems around programing overlaying complex and simple time signatures in many cases removing the need to make complicated tempo adjustments. when notating to sheet music the present inventions use of eight-notes for prime numbers under ten written in the denominator, keeps some continuity with current music notation practices.

An improved system of fractionally represented time signature for use in musical computer programs and metronomes wherein the numerator represents the number of beats per bar and the denominator represents the number of subdivisions per beat a further embodiment of said denominator allows that when bracketed said denominator represents the number of subdivisions per bar.

An improved system of fractionally represented time signature for use in musical computer programs and metronomes as claimed in claim 1 wherein, prime number denominators are musically notated as having the value of an eight-note or quaver for each division, as said prime number doubles so its notated value halves, prime number denominator values over 10 will be notated as having the value of a sixteenth note or semiquaver, prime number denominator values over 20 will be notated as having a value of a thirty-second note or demisemiquaver, when the denominator is bracketed all subdivisions are notated as having the value of an eight note.

An improved system of fractionally represented time signature for use in musical computer programs and metronomes as claimed in claim 1 wherein the concepts of beats per bar and subdivision per beat or bar are used to calculate bar length in any other visual style or configuration within the metronome or musical computer programs control system.

Transcription rules.

The first number describes the number of beats per bar, the second number describes the number of divisions per beat, when the first and second number are multiplied together the total number of divisions per bar is found. When the second number is bracketed it alone describes the total number of divisions per bar.

The transcribed note length of each division is governed by the second number and the rules are as follows.

Rule 1: as a prime number doubles so it's transcribed length is halved.

Rule 2: the number one has a value of a quarter note, (Crotchet)

Rule 3: prime numbers between one and eight have the value of an 8th note. (Quaver)

Rule 4: all numbers between eight and sixteen have the value of a 16th note except those numbers already affected by Rule 1. (Semiquaver)

Rule 5: all number between sixteen and thirty two are seen as having a value of a 32nd note except those numbers already affected by Rule 1. (Demisemiquaver)

Rule 6: all numbers above 32 are seen as having a value of a 64th note, except those numbers already affected by Rule 1. (Hemidemisemiquaver.) When the second number is bracketed (divisions per bar) all numbers are seen as having a value of an 8th note. In keeping with prior art when transcribing it may be courteous to add a numbered tie under the whole bar for easy of reading.

Rule 7: When the second number is bracketed (divisions per bar) all numbers above one are seen as having the value of an 8th note. (Quaver)

Referring to the figures, a system for fractionally representing time signatures for use in music computer programs and metronomes is presented as a computer program or an APP to be run on a smartphone or other computing device in order to allow a user to easily represent fractional time signatures. An introduction screen 110 is presented to the user when first accessing the system. Introduction screen 110 allows a user to select an input selection 115 by pressing on a touch-screen or using a mouse or other pointing device as is known in the art. Alternatively, introduction screen 110 may be timed to automatically move to the next screen or an informational video may be presented. As is known in the art, other environment enhancing routines may be run such as, but not limited to background music.

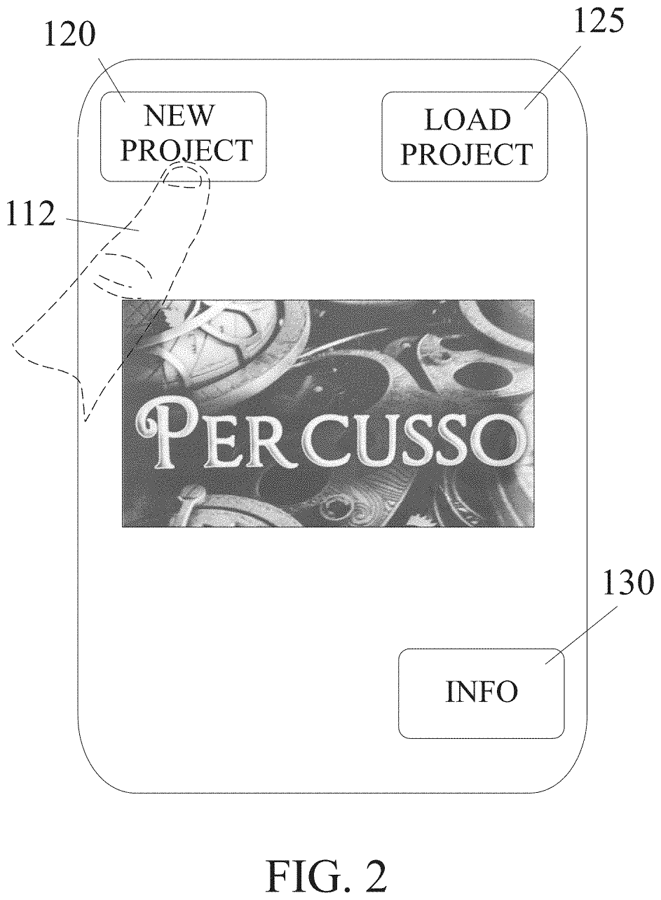

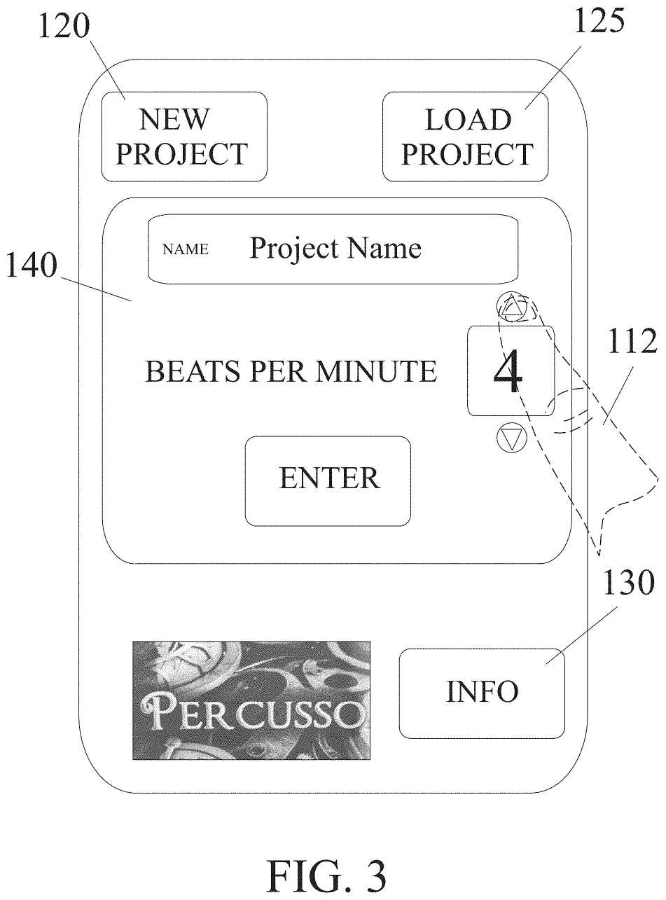

FIG. 2 displays a next selection screen with a new project input 120, a load project input 125 and an info input 125. Info input 125 is used to display general user help and information and may be context sensitive or may be generic help. When the user selects NEW PROJECT 120, a new screen opens as can be seen in FIG. 3. The user inputs a PROJECT NAME 140 and may select timing and press ENTER 135. Once a project is saved, that project may be opened using a LOAD input 125.

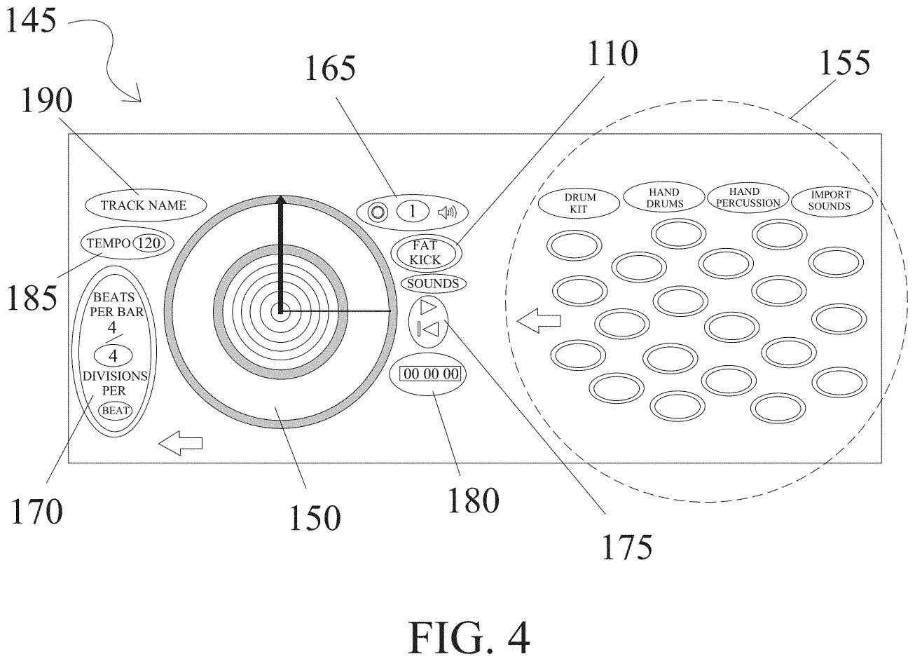

Referring to FIG. 4, an illustration of a screenshot showing a main screen 145 that displays a track visualization rings 150 and a sound bank 155. Also displayed are a track name 190 which is the name of the project that was entered under PROJECT NAME 140. A TEMPO Select input 185 is used to input the tempo desired. A timing select interface 170 is provided to set the musical timing and to change it. A TRACK SELECT input 165 displays the current track. A PLAY/PAUSE input 175 is used to start and stop. A SOUND input 160 displays the current sound effect selected from SOUND BANK 155. A RECORD input 180 is provided to control recording on selected track.

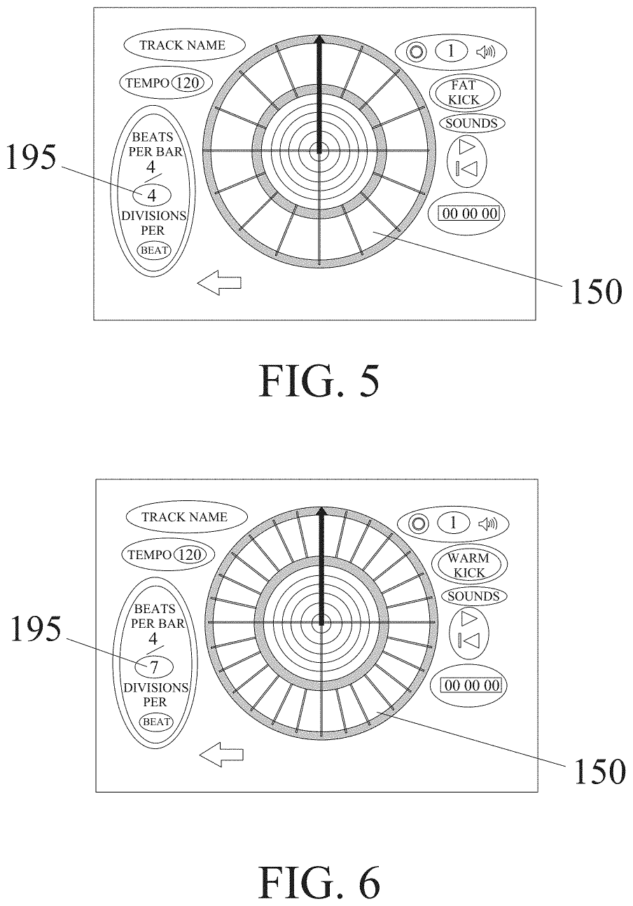

Referring to FIGS. 5 and 6, TRACK VISUALIZATION RINGS 150 shows the divisions as a function of a BEATS selection input 195. The visualization changes in response to the input and display a visual representation of the selected input.

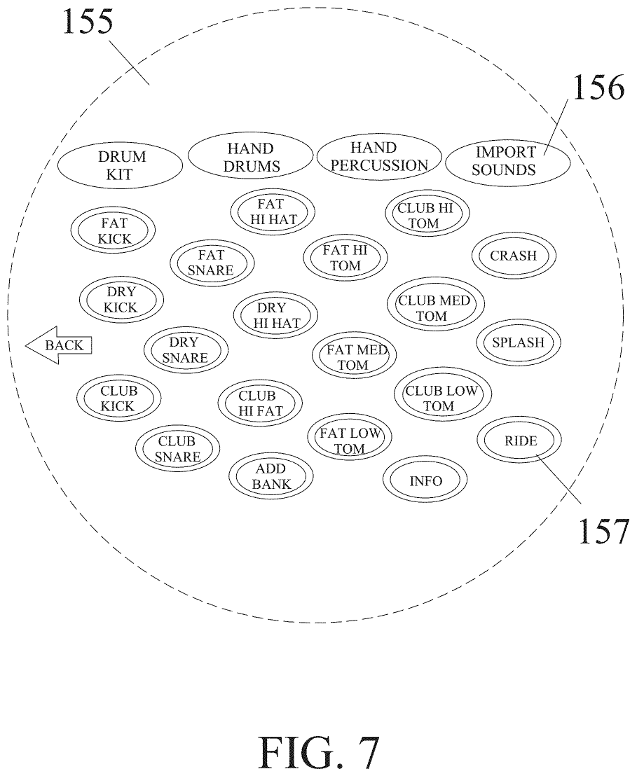

FIG. 7 is a close-up of SOUND Bank 155 that displays the various musical sounds that are available and is displayed on SOUND INPUT 160.

FIG. 8 shows a pop-up menu 205 allowing the user to manipulate various functions allowing the user to quickly perform the given functions.

Of course the exact displays shown may be graphically represented by differing means instead of rings such as, but not limited to, bars or other visual representation that quickly and easily allows the user to work with and quickly change the timing of musical compositions even when fractional time signatures are used.

Also, although touch screen operation is shown, other methods of imputing selections may be used, such as computer mice, computer pointing device, voice recognition or other suitable input method as is known in the art.

The rules presented are encoded as computer instructions that are executable instructions that are run within an electronic computing device. Often the electronic computing device is a mobile device such as a smart phone which is able to download and run an application, known as an APP.

The user is able to save each run as a user selected name and to recall the project at a later date. When a smart phone is utilized, the user inputs the information via a touch screen which makes entering the data very easy and intuitive. The graphical output clearly displays the result of the rules to provide the fractional time signature in a format that keeps some continuity with current music notation practices.

The improved system and method for f fractionally represented time signature for use in musical computer programs and metronomes wherein the numerator represents the number of beats per bar and the denominator represents the number of subdivisions per beat. Prime number denominators are musically notated as having the value of an eight-note or quaver for each division and therefore the prime number doubles which halves the notated value. Prime number denominator values over 10 are notated as having the value of a sixteenth note or semiquaver. Prime number denominator values over 20 are notated as having a value of a thirty-second note or demisemiquaver, when the denominator is bracketed all subdivisions are notated as having the value of an eight note. Additionally, beats per bar and subdivision per beat or bar are used to calculate bar length and are represented in a visual input and output.

Although the instant invention has been described in relation to particular embodiments thereof, many other variations and modifications and other uses will become apparent to those skilled in the art.

What is claimed is:

1. A system for fractionally representing time signature for use with digital device comprising:
a user interface that enables a user to enter a first number to represent the number of beats per bar; and to enter a second number to represent the number of divisions per beat;
a processing device in communication with said user interface whereby said processing device applies a set of transcription rules to said first and second numbers in response to user selected inputs; and
a graphical output in communication with said user interface whereby a visual representation of the desired fractional output is displayed.

2. The system of claim 1 wherein said user interface, storage device and processing device are integrated in a single unit.

3. The system of claim 2 wherein said processing device includes a non-transitory computer readable storage device and configured to execute the one or more software modules in order to apply said transcription rules.

4. The system of claim 3 wherein said one or more software modules is a downloadable smartphone app.

5. The system of claim 1 wherein said user interface is a touchscreen enabled computing device.

6. The system of claim 5 wherein said user interface includes a plurality of user selectable inputs whereby different musical effects are selected.

7. The system of claim 1 wherein the user interface enables the user to enter the desired time signature and wherein said processing device outputs a track visualization graphic having rings with divisions represented as a function of said second number input.

8. The system of claim 7 including an electronic storage system wherein a user project is saved in a computer readable storage device.

9. A method for fractionally representing time signatures for use in music computer programs and metronomes comprising the steps of:
entering, via an electronic processing device, a first number representing a number of beats per bar;
entering, via said electronic processing device, a second number representing a number of divisions per beat;
running a set of rules encoded as executable computer instructions provided to said electronic processing device wherein a result is calculated; and
displaying a graphical representation of said result on an electronic display.

10. The method from claim 8 wherein said electronic processing device includes a touch sensitive input device.

11. The method from claim 9 further comprising the step of entering, via touch sensitive input device, at least one musical effect.
